(19) United States
(12) Patent Application Publication
(10) Pub. No.: US 2019/0207386 A1
(43) Pub. Date: Jul. 4, 2019

(54) SURGE PROTECTION DEVICE STRUCTURE

(71) Applicant: CERAMATE TECHNICAL CO., LTD., New Taipei City (TW)

(72) Inventor: Hui-Ping WANG, New Taipei City (TW)

(21) Appl. No.: 15/861,672

(22) Filed: Jan. 4, 2018

(51) Int. Cl. H02H 9/04; H02H 9/02; H02H 7/20; H02H 3/08; H02H 9/00; H01C 7/12

(52) U.S. Cl. CPC H02H 9/042; H02H 9/02; H02H 7/20; H02H 9/044; H02H 9/005; H01C 7/12; H02H 3/08

(57) ABSTRACT

A surge protection device capable of avoiding current leakage and deterioration includes a first pin installed onto a varistor and electrically coupled to a first electrode, an insulation pad attached onto a side of the varistor and having a through hole configured to be corresponsive to a second electrode; a conductive component attached onto a side of the insulation pad, and the conductive component and the varistor sealing the through hole to form an air gap, and a second pin installed on the conductive component and passed through the air gap through a transient overvoltage to electrically conduct the second electrode.

### FIELD OF THE INVENTION

This disclosure relates to a surge protection device, and more particularly to the surge protection device capable of avoiding current leakage and deterioration.

### BACKGROUND OF THE INVENTION

To prevent surges such as pulse voltage or pulse current, a circuit generally comes with a surge protection device (SPD) connected in parallel with the circuit to protect a load device or other electronic components of the circuit. A common surge protection device (SPD) includes a metal oxide varistor (MOV) and a gas discharge tube (GDT).

However, the conventional MOV has the drawbacks of current leakage and deterioration, since the current may leak under the load of a power supply, and the leakage becomes increasingly greater with the ageing of the product. In addition, if the SPD simply adopts the MOV, both overheat and deterioration disengaging devices can be operated only if the MOV is damaged, but the current leakage and deterioration of the MOV cannot be prevented. On the other hand, when the GDT is used for power lightning protection, the GDT and power system may be damaged because the GDT has a follow current after lightning.

In view of the aforementioned drawbacks of the prior art, the discloser of this disclosure based on years of experience to conduct extensive research and experiment, and finally provided a feasible solution to overcome the drawbacks of the prior art.

### SUMMARY OF THE INVENTION

Therefore, it is a primary objective of this disclosure to provide a surge protection device structure connected in series with a varistor and an air gap to achieve the effects of avoiding current leakage and extending service life.

To achieve the aforementioned and other objectives, this disclosure provides a surge protection device structure comprising a varistor, a first pin, an insulation pad, a conductive component and a second pin. The first pin is installed onto the varistor and electrically coupled to a first electrode; the insulation pad is attached onto a side of the varistor and has a through hole configured to be corresponsive to a second electrode; the conductive component is attached onto a side of the insulation pad, and the conductive component and the varistor seal the through hole to form an air gap; and the second pin is installed onto the conductive component and passed through the air gap through a transient overvoltage to conduct with the second electrode.

Compared with the prior art, the surge protection device structure of this disclosure combines the varistor and the air gap, and when the surge protection device is connected in series with a power circuit, the resistance of the air gap is much greater than that of the varistor, so that the voltage is allocated to the air gap, and the varistor has no current leakage. In addition, when the lightning intrudes into the power circuit, and the surge protection device structure is operated, not much voltage allocated to the air gap remains. Since the resistance of the varistor is greater than that of the air gap, the voltage at the air gap is very small and there will be no operation, and the air gap will not produce a follow current. Such arrangement achieves the effects of avoiding the occurrence of current leakage and extending the service life.

### BRIEF DESCRIPTION OF THE DRAWINGS

FIG. 1 is an exploded view of a surge protection device structure of this disclosure;

FIG. 2 is a perspective view of a surge protection device structure of this disclosure;

FIG. 3 is a cross-sectional view of a surge protection device structure of this disclosure;

FIG. 4 is an exploded view of a surge protection device structure in accordance with another implementation mode of this disclosure;

FIG. 5 is a perspective view of a surge protection device structure in accordance with another implementation mode of this disclosure; and

FIG. 6 is a schematic view showing an application of a surge protection device structure in accordance with another implementation mode of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

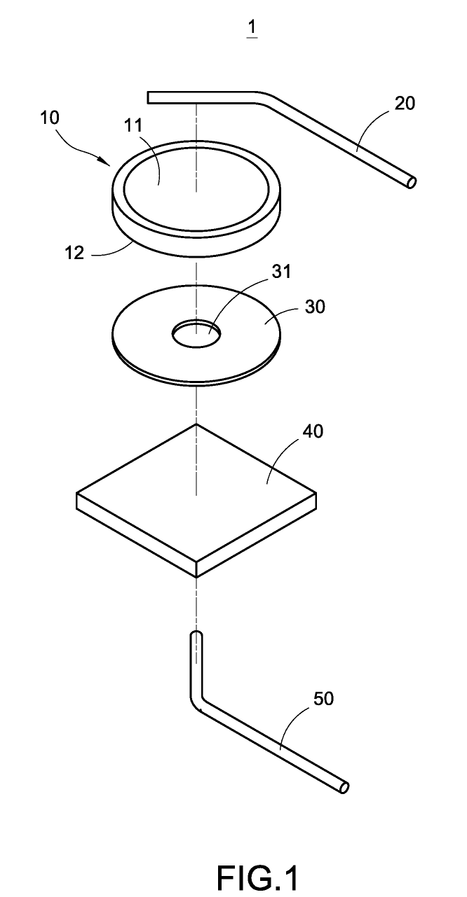

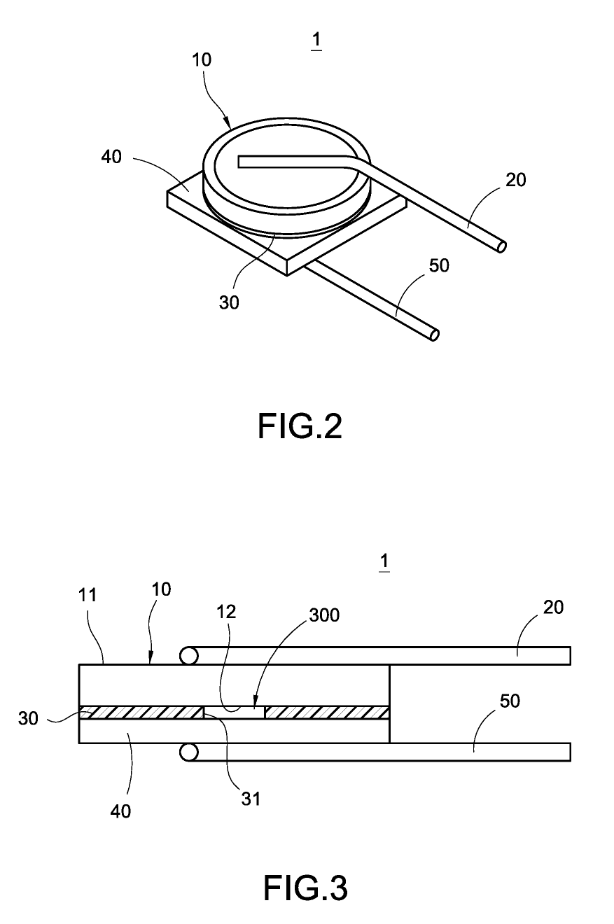

With reference to FIGS. 1 to 3 for an exploded view, a perspective view, and a cross-sectional view of a surge protection device structure in accordance with this disclosure respectively, the surge protection device structure 1 comprises a varistor 10, a first pin 20, an insulation pad 30, a conductive component 40 and a second pin 50. The insulation pad 30 has a through hole 31, and the insulation pad 30 is sandwiched between the varistor 10 and the conductive component 40. In addition, the first pin 20 is installed on an outer side of the varistor 10, and the second pin 50 is installed on an outer side of the conductive component 40, and these components form the surge protection device structure 1. The surge protection device structure 1 will be described in details below.

The varistor 10 has a first electrode 11 and a second electrode 12 disposed opposite to each other. In this preferred embodiment, the varistor 10 is a standalone metal oxide varistor (MOV). Of course, the varistor 10 of this disclosure is not limited to MOV only.

It is noteworthy that the varistor 10 in a conducted status has a specific internal resistance and will have a voltage drop when a surge flows through the varistor 10, so that the varistor 10 is a conductive component with the feature of limited voltage. Further, the installation of the varistor 10 has the advantages of large flow capacity, quick response, no follow current, and long service life. On the other hand, the varistor 10 has the disadvantages of creating a current leakage under the load of a power supply and the current leakage increasing with the ageing of the product.

The first pin 20 is installed onto the varistor 10 and electrically coupled to the first electrode 11. In this preferred embodiment, the first pin 20 is a bent conductive pin.

The insulation pad 30 is attached onto a side of the varistor 10, and the insulation pad 30 has a through hole 31 configured to be corresponsive to the second electrode 12. Specifically, the insulation pad 30 is made of an insulating material, and preferably the insulation pad 30 is in a shape corresponding to the shape of the varistor 10, and both of them are in a circular shape.

In addition, the conductive component 40 is attached onto a side of the insulation pad 30. In addition, the conductive component 40 and the varistor 10 seal the through hole 31 of the insulation pad 30 to form an air gap 300. In this preferred embodiment, the conductive component 40 is a conductive plate. Of course, the actual implementation is not limited to such arrangement only, but the conductive component 40 can also be an electrode plate or another varistor.

It is noteworthy that both sides of the insulation pad 30 have a soldering material (not shown in the figures) disposed thereon to facilitate soldering the varistor 10 or the conductive component 40 in order to provide a tight connection and form a path.

The second pin 50 is installed onto the conductive component 40 and passed through the air gap 300 through a transient overvoltage and electrically conducted with the second electrode 12.

It is noteworthy that when the air gap 300 is situated at a conducted status, the internal resistance drops drastically, and finally approaches zero. This is a switch type feature. The air gap 300 has the advantages of large flow capacity, low residual voltage, no current leakage, and long service life. On the other hand, the air gap 300 has the disadvantages of having a follow current when the air gap 300 is used in DC or power frequency voltage, and a too-slow response time.

With reference to FIG. 3 for a preferred embodiment of this disclosure, the air gap 300 is formed between the varistor 10 and the conductive component 40 by the configuration of the insulation pad 30 and its through hole 31.

More specifically, the applications of the varistor 10 and the air gap 300 in the field of surge and overvoltage protection have similar features such as large flow capacity, low residual voltage, etc. However, the varistor 10 in the conducted status has current leakage but no follow current. On the other hand, the air gap 300 has follow current but no current leakage.

The surge protection device structure 1 of this disclosure combines the varistor 10 and the air gap 300. When the surge protection device structure 1 is connected in series with a power circuit, the resistance of the air gap 300 of the surge protection device structure 1 is much greater than that of the varistor 10, so that almost the whole of the voltage is allocated to the air gap 300, and the voltage at the varistor 10 is very small, and normally there is no current leakage of the varistor 10. When lightning intrudes into a power circuit, the surge protection device structure 1 is operated, and the varistor 10 is a voltage limiting component having a voltage greater than the working voltage of the power supply, and not much of the voltage allocated to the air gap 300 remains. In the meantime, the resistance of the varistor 10 is greater than that of the air gap 300. Now, the voltage at the air gap 300 is very small, and there is no operation, so that the air gap 300 will not produce a follow current.

Therefore, the surge protection device structure 1 of this disclosure has the features of large flow capacity, low residual voltage, no follow current, no current leakage, and an uneasily aged varistor 10. When the surge protection device structure 1 is applied to a power cable, situations such as spontaneous combustions or explosions will not occur easily. Therefore, the surge protection device structure 1 of this disclosure is preferably connected in series with the varistor 10 and the air gap 300 to achieve a better effect.

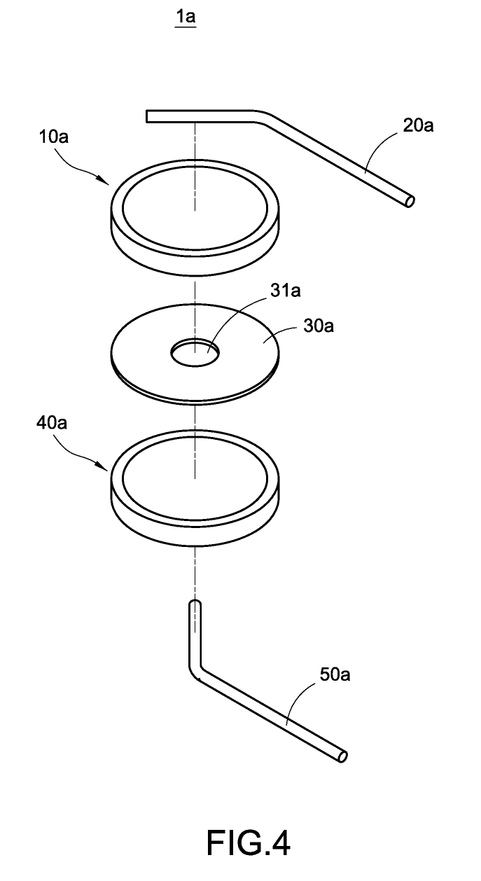

With reference to FIGS. 4 to 6 for an exploded view, a perspective view and a schematic view of a surge protection device structure in accordance with another implementation mode of this disclosure, the surge protection device structure 1a as shown in FIG. 4 comprises a varistor 10a, a first pin 20a, an insulation pad 30a, a conductive component 40a and a second pin 50a, and the insulation pad 30a has a through hole 31a. The conductive component 40a and the varistor 10a seal the through hole 31a of the insulation pad 30a to form an air gap 300a.

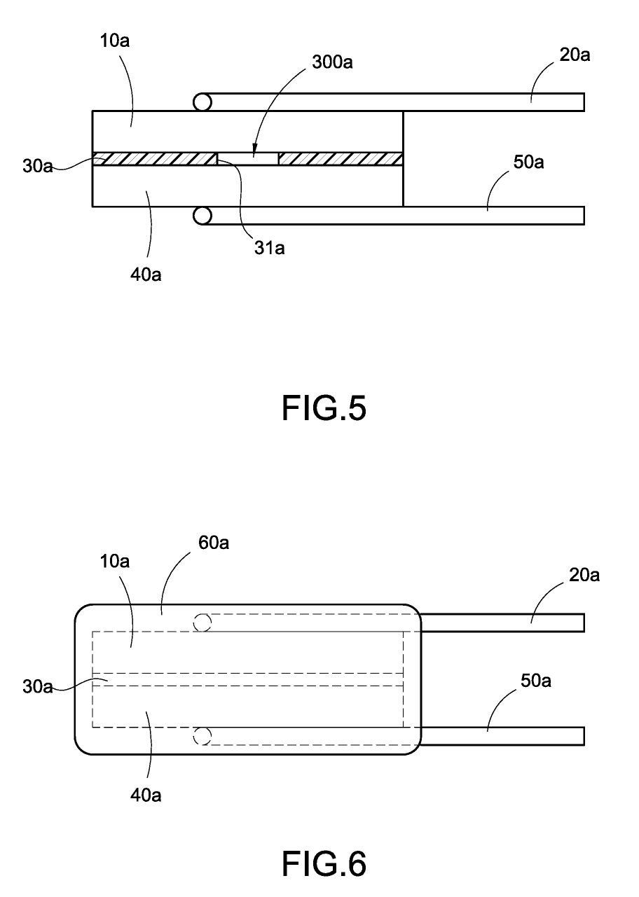

The difference between this preferred embodiment and the previous embodiment resides on that the conductive component 40a is another varistor. In FIG. 5, the insulation pad 30a is sandwiched between the varistor 10a and the conductive component 40a. Specifically, the insulation pad 30a of this preferred embodiment is installed between the two varistors, wherein the two varistors are conductive electrodes. Further, the first pin 20a and the second pin 50a are installed on the outer sides of the two varistors respectively to form the surge protection device structure 1a.

In FIG. 6, the surge protection device structure 1a of this disclosure further comprises a housing 60a for covering the varistor 10a, the insulation pad 30a and the conductive component 40a and exposing a portion of the first pin 20a and the second pin 50a. Such single varistor 10a and the air gap 300a are used to gain the advantages of low price and good feature and comply with the light, thin, short and compact requirements of components.

While this disclosure has been described by means of specific embodiments, numerous modifications and variations could be made thereto by those skilled in the art without departing from the scope and spirit of this disclosure set forth in the claims.

What is claimed is:

1. A surge protection device structure, comprising:
a varistor, having a first electrode and a second electrode disposed opposite to each other;
a first pin, installed onto the varistor and electrically coupled to the first electrode;
an insulation pad, attached onto a side of the varistor, and having a through hole configured to be corresponsive to the second electrode;
a conductive component, attached onto a side of the insulation pad, and the conductive component and the varistor sealing the through hole to form an air gap;
and a second pin, installed onto the conductive component, and passed through the air gap through a transient overvoltage and electrically coupled to the second electrode.

2. The surge protection device structure of claim 1, wherein the varistor is a metal oxide varistor.

3. The surge protection device structure of claim 1, wherein the insulation pad is in a shape corresponding to the shape of the varistor, and both of the insulation pad and the varistor are in a circular shape.

4. The surge protection device structure of claim 1, wherein the insulation pad is made of an insulating material, and both sides of the insulation pad further have a soldering material disposed thereon.

5. The surge protection device structure of claim 1, further comprising a housing for covering the varistor, the insulation pad and the conductive plate, and exposing a portion of the first pin and the second pin.

6. The surge protection device structure of claim 1, wherein the conductive component is a conductive plate.

7. The surge protection device structure of claim 1, wherein the conductive component is another varistor.
